(19) United States
(12) Patent Application Publication
(10) Pub. No.: US 2004/0040547 A1
(43) Pub. Date: Mar. 4, 2004

(54) Self latching canister vent solenoid valve

(76) Inventors: Kirk Ivens, Chatham (CA); Russell Miles Modien, Chatham (CA)

Correspondence Address: Siemens Corporation, Intellectual Property Department, 186 Wood Avenue South, Iselin, NJ, 08830, US

(21) Appl. No.: 10/245,743

(22) Filed: Sep. 17, 2002

Related U.S. Application Data
(60) Provisional application No. 60/407,762, filed on Aug. 30, 2002.

(51) Int. Cl. G01M 19/00

(52) U.S. Cl. 123/520; 73/118.1; 251/129.03

(57) ABSTRACT

A vent solenoid valve for use in an automotive emission system. The vent valve includes a housing having a canister port and an atmospheric port. The housing includes a bobbin having a coil for generating a magnetic field wherein the bobbin includes an internal channel. A stator is located in an upper portion of the channel and a stop element is located near a lower portion of the channel. The vent valve further includes an armature having a permanent magnet and a valve element, wherein the magnet is located in the channel and is moveable therein to enable movement of the valve element between a closed position wherein the canister port is isolated from the atmospheric port and an open position for enabling fluid communication between the canister port and the atmospheric port. When the coil is energized with a predetermined polarity, the valve element moves to the open position and is kept in the open position by magnetic attraction between the magnet and the stator. Further, when the coil is energized with a reverse polarity, the first magnetic attraction is overcome to move the valve element to the closed position wherein the valve element is kept in the closed position by a second magnetic attraction between the magnet and the stop.

### CROSS REFERENCE TO RELATED APPLICATION AND PRIORITY CLAIM

This application claims the benefit of U.S. Provisional Application No. 60/407,762 (Attorney Docket No. 2002 P 14197 US) filed on Aug. 30, 2002 in the name of Kirk Ivens and Russell Miles Modien and entitled SELF LATCHING CANISTER VENT SOLENOID USING PERMANENT MAGNETS, which is incorporated by reference herein in its entirety.

### FIELD OF THE INVENTION

This invention relates to evaporative emission control systems for internal combustion engines, and more particularly, to a canister vent solenoid valve which utilizes a permanent magnet for maintaining valve position.

### BACKGROUND OF THE INVENTION

Motor vehicles having an internal combustion engine typically include an evaporative emission control system for reducing fuel vapor emissions. Such systems include a vapor collection canister which serves to absorb fuel vapors that are generated within a fuel system. The canister includes a vent solenoid valve which is opened under the appropriate conditions so as to place the canister in fluid communication with atmospheric air. This enables vacuum generated by the engine to draw in atmospheric air through the canister and then draw out the fuel vapors from the canister as part of a process for purging the canister.

Alternatively, the vent solenoid valve is closed to isolate the canister from atmospheric air. This enables the performance of a selected on board diagnostic procedure for detecting whether there is a fuel vapor leak in the system that is above a predetermined level. The vent solenoid valve includes a solenoid for moving a valve element between the open and closed positions. In a conventional vent solenoid valve, the solenoid is energized in order to move the valve element to the closed position. Further, the solenoid must continue to be energized for the valve element to remain in the closed position. A spring is utilized to return the valve to the open position when power to the solenoid is removed.

However, the use of such vent solenoid valves increases the amount of components needed and thus ultimately increases costs. Further, many engines are becoming smaller in capacity, resulting in smaller capacity alternators and thus less electrical power which is available for energizing such solenoids.

### SUMMARY OF THE INVENTION

The invention is directed to a vent solenoid valve for use in an automotive emission system. The vent valve includes a housing having a canister port and an atmospheric port. The housing includes a bobbin having a coil for generating a magnetic field wherein the bobbin includes an internal channel. A stator is located in an upper portion of the channel and a stop element is located near a lower portion of the channel. The vent valve further includes an armature having a permanent magnet and a valve element, wherein the magnet is located in the channel and is moveable therein to enable movement of the valve element between a closed position wherein the canister port is isolated from the atmospheric port and an open position for enabling fluid communication between the canister port and the atmospheric port. When the coil is energized with a predetermined polarity, the valve element moves to the open position and is kept in the open position by a first magnetic attraction between the magnet and the stator. Further, when the coil is energized with a reverse polarity, the first magnetic attraction is overcome to move the valve element to the closed position wherein the valve element is kept in the closed position by a second magnetic attraction between the magnet and the stop.

The features of the invention believed to be novel are set forth with particularity in the appended claims. The invention itself, however, both as to organization and method of operation, may be best understood by reference to the following description taken in conjunction with the accompanying figures.

### BRIEF DESCRIPTION OF THE DRAWINGS

FIG. 1 is a cross sectional view of vent solenoid valve in accordance with the present invention.

FIG. 2 is an illustrative depiction of an emission control system which includes the vent solenoid valve.

### DETAILED DESCRIPTION OF THE INVENTION

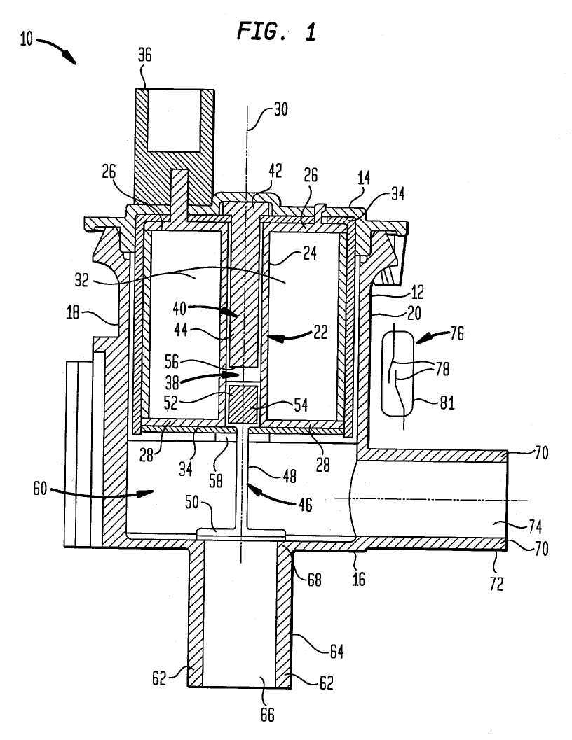

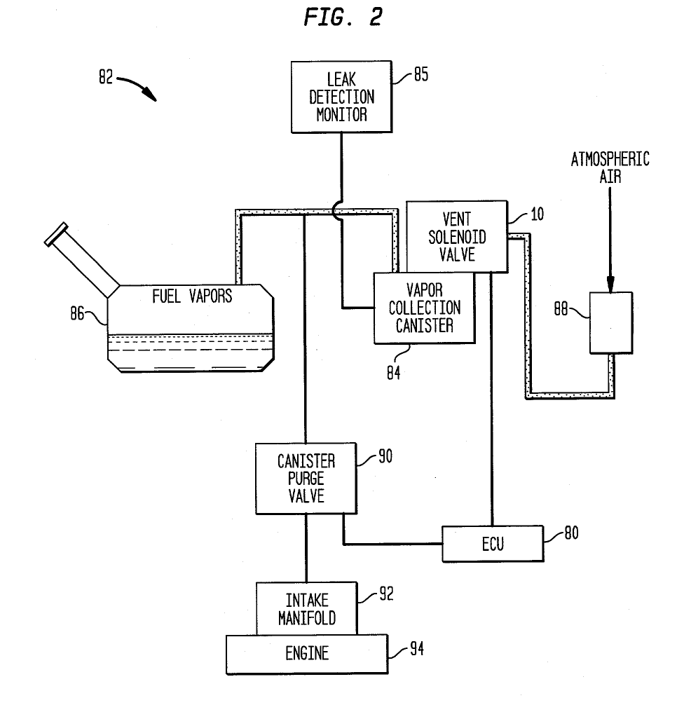

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of FIGS. 1-2.

Referring to FIG. 1, a cross sectional view of a vent solenoid valve 10 in accordance with the present invention is shown. The vent valve 10 includes a generally cylindrically shaped housing 12 having upper 14 and lower 16 walls and left 18 and right 20 side walls. The housing 12 includes a bobbin 22 having a center member 24 positioned between upper 26 and lower 28 flanges that lie circumferentially about a center axis 30. A coil 32 is positioned between the upper 26 and lower 28 flanges. The bobbin 22 resides within an enclosure 34 fabricated from a ferromagnetic material such as steel. A connector 36 extends from the housing 12 which serves to transmit electrical power from a power source to the coil 32 for forming a magnetic field.

The center member 24 includes a channel 38 that extends between the upper 26 and lower 28 flanges and through the enclosure 34. In addition, the housing 12 includes a stator element 40 having a head portion 42 and a stator shaft 44 that extends into the channel 38 to form a substantially T-shaped configuration. The stator element 40 is affixed to the bobbin 22 and is also fabricated from a ferromagnetic material.

An armature 46 is positioned in a cooperative relationship with the stator element 40 to form a solenoid. The armature 46 includes a valve shaft 48 located between a valve element 50 and a magnet element 52. The magnet element 52 includes a permanent magnet 54 and is located in the channel 38 between a lower end 56 of the stator shaft 44 and a lip or stop 58 that extends from the enclosure 34. The magnet element 52 may be moved along the center axis 30 within the channel 38 so as to enable upward and downward movement of the armature 46 relative to the stator element 40.

The housing 12 further includes an internal passageway 60 located between the enclosure 34 and the lower wall 16. Canister port walls 62 extend from the lower wall 16 to form a canister port 64 having a first passageway 66 which is in fluid communication with a vapor collection canister 84 (FIG. 2). A valve seat 68 for receiving the valve element 50 is formed at the intersection of the canister port walls 62 and the lower wall 16. Atmospheric port walls 70 extend from the right side wall 20 to form an atmospheric port 72 having a second passageway 74 which is in fluid communication with atmospheric air through a filter 88 (FIG. 2).

In FIG. 1, the valve element 50 is shown in a closed position. In this position, the valve element 50 is in contact with the valve seat 68 to thus close the canister port 64 and isolate the canister port 64 from the atmospheric port 72. In addition, the magnet element 52 is located adjacent the stop 58 to enable magnetic attraction between the magnet element 52 and the stop 58. In accordance with the present invention, the magnetic attraction keeps the valve element 50 in the closed position. As such, electrical power is not needed to maintain the valve element 50 in the closed position.

The valve element 50 is also moveable to an open position. In the open position, the valve element 50 is located above the valve seat 68 to enable fluid communication between the canister port 64, the internal passageway 60 and the atmospheric port 72. The valve element 50 is moved to the open position by first energizing the coil 32 with electrical power having a predetermined polarity sufficient to overcome the magnetic attraction between the magnet element 52 and the stop 58. The valve element 50 continues to move upward from the closed position until the magnet element 52 is adjacent the lower end 56. This results in magnetic attraction between the magnet element 52 and the lower end 56 which serves to keep the valve element 50 in the open position. As such, electrical power is not needed to maintain the valve element 50 in the open position and may be turned off.

In order to move the valve element 50 back to the closed position, the coil 32 is again energized with electrical power, but with a reversed polarity, which is sufficient to overcome the magnetic attraction between the magnet element 52 and lower end 56. The valve element 50 continues to move downward until contact is made between the valve element 50 and the valve seat 68 and the magnet element 52 is located adjacent the stop 58. This enables magnetic attraction between the magnet element 52 and the stop 58 which serves to keep the valve element 50 in the closed position as previously described. As such, electrical power is not needed to maintain the valve element 50 in the closed position and may again be turned off.

Accordingly, the coil 32 is only energized to overcome the magnetic attraction between the magnet element 52 and either the stop 58 or lower end 56 and to move the valve element 50 to either the open or closed position. Further, the magnet element 52 serves to keep the valve element 50 in either the open or closed position. Once the valve element 50 is in either position, power to the coil 32 may be removed, resulting in less power usage than in conventional vent valves. In addition, the present invention also eliminates the need for a return spring to move the valve element 50 to its original position as in a conventional vent valve.

A switch may be used to provide feedback information regarding the position of the valve element to an engine electronic control unit (ECU) 80. By way of example, a mechanical switch may be used that is actuated through contact with the armature 46 when the valve element 50 is in either the open or closed position, as desired. Actuation of the switch then enables the ECU 80 to determine the position of the valve element 50.

Alternatively, a switch that does not require actual contact for actuation may be used such as a magnetic reed switch. Referring to FIG. 1, an illustrative depiction of a magnetic reed switch 76 is shown. The switch 76 includes two magnetizable contacts 78 located in a glass tube or other container 81 filled with a protective gas. The switch 76 is located adjacent the housing 12 such that when the valve element 50 is in the open position, the magnet element 52 is sufficiently close to the contacts 78 to cause the contacts 78 to become magnetized and attracted to each other. This closes the switch 76 and enables the ECU 80 to determine the position of the valve element 50. When the magnet element 52 is moved away from the contacts 78, the contacts 78 demagnetize and separate, thus opening the switch 76. It is noted that the location of the switch 76 shown in FIG. 1 is for illustrative purposes only and that the switch 76 may be located such that the switch 76 is closed when the valve element 50 is in the closed position.

Referring to FIG. 2, the vent valve 10 in accordance with the present invention is shown in an emission control system 82. The system 82 includes a leak detection monitor 85 which is used as part of a selected on board diagnostic procedure for determining whether there is a fuel vapor leak in the system 82 that is above a predetermined level.

The canister 84 is in fluid communication with a fuel tank 86 and includes carbon or other similar material which serves to absorb fuel vapors that are generated within the fuel tank 86 and in the emission control system 82. The canister 84 includes the vent valve 10 which is opened under the appropriate conditions so as to place the canister 84 in fluid communication with atmospheric air through the filter 88 as described in relation to FIG. 1. Alternatively, the vent valve 10 is closed as previously described to isolate the canister 84 from atmospheric air so as to enable performance of the on board diagnostic procedure.

A canister purge valve 90 is located between the canister 84 and an engine intake manifold 92 of an internal combustion engine 94. The canister purge valve 90 may be opened to place the canister 84 in fluid communication with the intake manifold 92. Alternatively, the canister purge valve 90 may be closed to isolate the canister 84 from the intake manifold 92. The opening and closing of both the canister purge valve 90 and the vent valve 10 is controlled by the ECU 80.

Under the appropriate conditions, the canister 84 is purged so that fuel vapors collected within the canister 84 do not undesirably escape into the atmosphere. This is done by opening the canister purge valve 90 and the vent valve 10, thus enabling vacuum which is present at the intake manifold 92 to draw in atmospheric air through the canister 84 and then draw out the fuel vapors from the canister 84. The purged fuel vapors are then used in the normal combustion process. The ECU 80 determines when purging is to occur based on received signals indicative of various engine parameters. Further, the ECU 80 may be programmed to allow purging of the canister 84 at differential rates depending upon the prevailing engine operating conditions. As such, greater amounts of purging may be permitted at certain times while at other times lesser amounts may be allowed.

While the invention has been described in conjunction with specific embodiments, it is evident that many alternatives, modifications, permutations and variations will become apparent to those skilled in the art in light of the foregoing description. In particular, it noted that more than one magnet may be used. Further, the entire enclosure 34 may be substituted with a separate stop element located near the bottom of the channel 38. In addition, the vent valve 10 may be configured such that the magnet element 52 magnetically attracts a top portion of the enclosure 34 rather than the lower end 56 to move the valve element 50 to the open position. Accordingly, it is intended that the present invention embrace all such alternatives, modifications and variations as fall within the scope of the appended claims.

What is claimed is:

1. A solenoid, comprising:
a bobbin having a coil for generating a magnetic field, said bobbin including an internal channel;
a stator located within said channel; and
an armature having a permanent magnet, wherein said permanent magnet is located in said channel to enable movement of said armature between first and second positions relative to said stator and wherein said armature is kept in said first position by magnetic attraction between said magnet and said stator.

2. The solenoid according to claim 1 further including a stop element which is spaced apart from said stator and wherein said armature is moveable between said stator and said stop element.

3. The solenoid according to claim 2 wherein said armature is kept in said second position by magnetic attraction between said magnet and said stop element.

4. The solenoid according to claim 3 wherein said armature is moved to said first position by energizing said coil to overcome the magnetic attraction between said magnet and said stop element to move said armature to said first position.

5. The solenoid according to claim 1 wherein said armature is moved to said second position by energizing said coil to overcome the magnetic attraction between said magnet and said stator to move said armature to said second position.

6. The solenoid according to claim 1 further including a switch for determining a position of said armature.

7. The solenoid according to claim 6 wherein said switch is a reed switch.

8. A method for operating a valve, comprising the steps of:
generating a magnetic field for overcoming a first magnetic attraction and for moving a valve from a first position to a second position;
providing a permanent magnet for magnetically attracting said valve to a housing to form a second magnetic attraction for maintaining said valve in said second position; and
reversing said magnetic field to overcome said second magnetic attraction and for moving said valve to said first position wherein said permanent magnet magnetically attracts said valve to said housing to form said first magnetic attraction, wherein said first magnetic attraction maintains said valve in said first position.

9. The method according to claim 8, wherein said valve includes said permanent magnet.

10. The method according to claim 8, wherein said first magnetic attraction is between a stator and said permanent magnet.

11. The method according to claim 8, wherein said second magnetic attraction is between a stop element and said permanent magnet.

12. The method according to claim 8 further including a switch for determining a position of said valve.

13. The method according to claim 12 wherein said switch is a reed switch.

14. The method according to claim 8 wherein said first and second magnetic fields are de-energized when said first and second magnetic attractions are formed.

15. A vent solenoid valve for use in an automotive emission system, comprising:
a housing having a canister port and an atmospheric port;
a bobbin having a coil for generating a magnetic field, said bobbin including an internal channel;
a stator located in an upper portion of said channel;
a stop element located near a lower portion of said channel;
an armature having a permanent magnet and a valve element, wherein said magnet is located in said channel and is moveable therein to enable movement of said valve element between a closed position wherein said canister port is isolated from said atmospheric port and an open position for enabling fluid communication between said canister port and said atmospheric port and wherein when said coil is energized with a predetermined polarity, said valve element moves to said open position and is kept in said open position by a first magnetic attraction between said magnet and said stator and when said coil is energized with a reverse polarity, said first magnetic attraction is overcome to move said valve element to said closed position and wherein said valve element is kept in said closed position by a second magnetic attraction between said magnet and said stop.

16. The vent solenoid according to claim 15, wherein said coil is not energized when said valve element is kept in said open and closed positions by said first and second magnetic attractions, respectively.

17. The vent solenoid valve according to claim 15, wherein said stator and said stop element are fabricated from a ferromagnetic material.

18. The vent solenoid valve according to claim 15 further including a switch for determining a position of said valve element.

19. The vent solenoid valve according to claim 15 wherein said switch is a reed switch.

20. An evaporative emission control system, wherein said system is in fluid communication with a fuel tank that generates fuel vapors, comprising:
a vapor collection canister in fluid communication with said fuel tank for absorbing fuel vapors in said system;
a vent valve in fluid communication with said canister for enabling venting of said canister to atmosphere, wherein said vent valve comprises:
a housing having a canister port and an atmospheric port;
a bobbin having a coil for generating a magnetic field, said bobbin including an internal channel;
a stator located in an upper portion of said channel;
a stop element located near a lower portion of said channel;
an armature having a permanent magnet and a valve element, wherein said magnet is located in said channel and is moveable therein to enable movement of said valve element between a closed position wherein said canister port is isolated from said atmospheric port and an open position for enabling fluid communication between said canister port and said atmospheric port and wherein when said coil is energized with a predetermined polarity, said valve element moves to said open position and is kept in said open position by a first magnetic attraction between said magnet and said stator and when said coil is energized with a reverse polarity, said first magnetic attraction is overcome to move said valve element to said closed position and wherein said valve element is kept in said closed position by a second magnetic attraction between said magnet and said stop;
a leak detection monitor for determining whether there are leaks in said system which are greater than a predetermined level;
a canister purge valve for purging said canister; and
an electronic engine control unit for controlling opening and closing of said vent valve and said canister purge valve to enable purging of said canister and performance of an on board diagnostic procedure, wherein said engine control unit includes drivers for energizing said pick and release coils.
